(19) United States
(12) Patent Application Publication
(10) Pub. No.: US 2021/0409204 A1
(43) Pub. Date: Dec. 30, 2021

(54) ENCRYPTION OF PROTECTED DATA FOR TRANSMISSION OVER A WEB INTERFACE

(71) Applicant: Bank of America Corporation, Charlotte, NC (US)

(72) Inventors: Michael W. Wronski, Simi Valley, CA (US); Mangesh M. Auti, Frisco, TX (US); Jatinkumar Pramodbhai Patel, Plano, TX (US); Lata Meda, Simi Valley, CA (US); Sita Rukmini Vuppala, Frisco, TX (US); Carl. M. Benda, Charlotte, NC (US); Lakshmi L. Karuppiah, West Hills, CA (US)

(21) Appl. No.: 16/916,972

(22) Filed: Jun. 30, 2020

(51) Int. Cl. H04L 9/08; G06F 16/248; H04L 9/32

(52) U.S. Cl. CPC H04L 9/0866; G06F 16/248; H04L 9/3236; H04L 9/3228; H04L 9/0877

(57) ABSTRACT

Aspects of the disclosure relate to encryption of protected data for data transmission over a web interface. A computing platform may submit, via a first computing device, a query for data associated with a user. The computing platform may receive a search result comprising an attribute of the user. Then, the computing platform may generate, based on the attribute of the user, a data file comprising an attribute identifier associated with the attribute of the user. Then, the computing platform may upload, via a web interface and to a second computing device, the data file comprising the attribute identifier. Subsequently, the computing platform may receive, via the web interface and from the second computing device, an encryption key corresponding to the attribute identifier. Then, the computing platform may store, via the first computing device and in a database, an association between the attribute, the attribute identifier, and the encryption key.

### BACKGROUND

Aspects of the disclosure relate to deploying digital data processing systems for secure transmission of protected data. In particular, one or more aspects of the disclosure relate to encryption of protected data for data transmission over a web interface.

In the performance of its various functions, an enterprise organization may need to process, store, transmit, and/or modify data related to personal information. Generally, some of the information may be protected data, whereas some other information may be non-protected data. In some instances, such information may be vulnerable to a data breach that may compromise security of the protected data. Ensuring security of the data transmission may be highly advantageous to providing reliable enterprise functions. In many instances, however, it may be difficult to provide data security with speed and accuracy, while also attempting to optimize network resources, bandwidth utilization, and efficient operations of the associated computing infrastructure.

### SUMMARY

Aspects of the disclosure provide effective, efficient, scalable, fast, reliable, and convenient technical solutions that address and overcome the technical problems associated with encryption of protected data for data transmission over a web interface.

In accordance with one or more embodiments, a computing platform having at least one processor, and memory storing computer-readable instructions that, when executed by the at least one processor, cause the computing platform to submit, via a first computing device, a query for data associated with a user. Subsequently, the computing platform may receive, via the first computing device, a search result comprising an attribute of the user. Then, the computing platform may generate, based on the attribute of the user, a data file comprising an attribute identifier associated with the attribute of the user. Then, the computing platform may upload, via a web interface and to a second computing device, the data file comprising the attribute identifier. Subsequently, the computing platform may receive, via the web interface and from the second computing device, an encryption key corresponding to the attribute identifier. Then, the computing platform may store, via the first computing device and in a database, an association between the attribute, the attribute identifier, and the encryption key.

In some embodiments, providing the data file may include removing, after an elapse of a time threshold, the data file from the web interface.

In some embodiments, the computing platform may modify, based on the search result, a table storing the attribute of the user.

In some embodiments, the computing platform may receive, via the first computing device and over a secured network, a second query comprising the identifier. Then, the computing platform may match, via the first computing device and in the database, the identifier with the attribute associated with the user. Subsequently, the computing platform may retrieve, via the first computing device and from the database, the attribute. Then, the computing platform may provide, based on the second query and over the secured network, the attribute.

In some embodiments, the computing platform may receive, via the first computing device and over the web interface, a second query comprising the encryption key. Then, the computing platform may match, via the first computing device and in the database, the encryption key with the attribute associated with the user. Subsequently, the computing platform may retrieve, via the first computing device and from the database, a link to the attribute. Then, the computing platform may cause, based on the second query, the link to the attribute be provided over an authenticated network.

In some embodiments, the encryption key may be based on a unidirectional hashing algorithm.

In some embodiments, the computing platform may generate the query in JavaScript Object Notation (JSON) format. Then, the computing platform may validate, based on the JSON format, the search result.

In some embodiments, the database may be a Relational Database Management System (RDBMS).

In some embodiments, the computing platform may determine, based on the web interface, a size of a batch comprising a plurality of data files associated with a plurality of users. Then, the computing platform may generate, based on the size, the batch of the plurality of data files. Subsequently, the computing platform may upload, via the web interface and to the second computing device, the batch. Then, the computing platform may remove, after a time interval, the batch from the web interface. In some embodiments, the computing platform may determine the size of the batch to minimize the time interval for the batch to remain on the web interface.

In some embodiments, the computing platform may receive, via the web interface, an error message indicative of a failure to upload the batch. Subsequently, the computing platform may repeat, via the web interface and based on the error message, the upload of the batch. In some embodiments, the computing platform may modify the size of the batch based on the error message.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for encryption of protected data for data transmission over a web interface;

FIG. 2 depicts an illustrative data flow for encryption of protected data for data transmission over a web interface;

FIG. 3 depicts an illustrative method for encryption of protected data for data transmission over a web interface; and

FIG. 4 depicts another illustrative method for encryption of protected data for data transmission over a web interface.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Enterprise users (e.g., employees of an enterprise organization, such as a financial institution) generally have access to confidential and sensitive protected data associated with the enterprise organization and/or customers of the enterprise organization. An enterprise organization has a duty and a responsibility to protect such protected data. In many instances, confidential and secure protected data may be vulnerable to unauthorized access and/or misappropriation. Accordingly, it may be of high significance for an enterprise organization to devise ways in which to protect the integrity of protected data. Fast and reliable responses to potential request for protected data, while maintaining data integrity in transmission and storage, may be of high significance to ensuring enterprise security.

Some aspects of the disclosure relate to encryption of protected data for data transmission over a web interface. For example, an encryption key associated with protected data may be stored within an enterprise organization, and the encryption key may be shared with external parties, such as partners, marketing platforms, social networking platforms, and so forth. In addition to protecting user data, such techniques to protect data and its integrity may include advantages for an enterprise business such as, for example, preventing a loss of reputation in a marketplace, minimizing litigation, minimizing loss of business engagements and/or partnerships, and minimizing loss resulting from other tangible and intangible business opportunities.

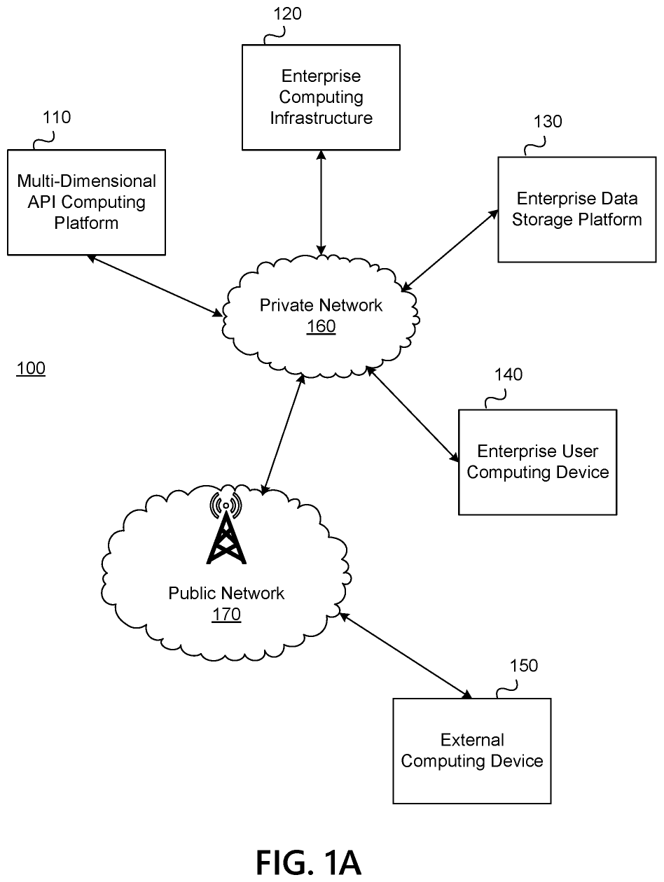

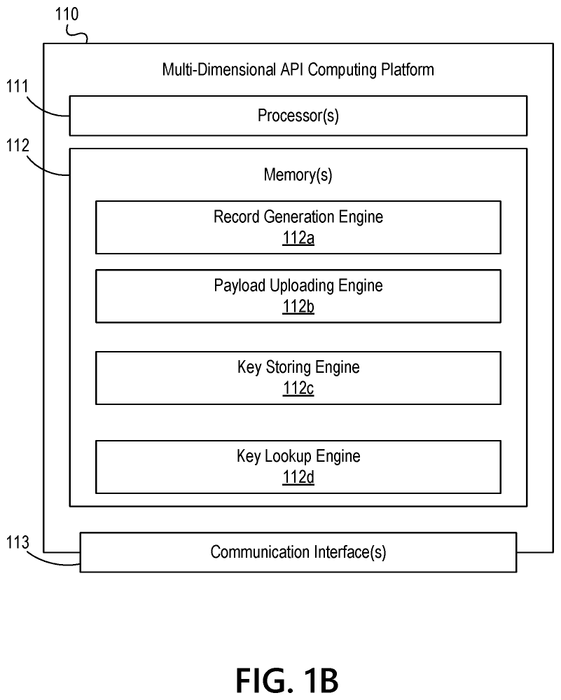

FIGS. 1A and 1B depict an illustrative computing environment for encryption of protected data for data transmission over a web interface. Referring to FIG. 1A, computing environment 100 may include one or more computer systems. For example, computing environment 100 may include a multi-dimensional API computing platform 110, enterprise computing infrastructure 120, an enterprise data storage platform 130, enterprise user computing device 140, and an external computing device 150.

As illustrated in greater detail below, multi-dimensional API computing platform 110 may include one or more computing devices configured to perform one or more of the functions described herein. For example, multi-dimensional API computing platform 110 may include one or more computers (e.g., laptop computers, desktop computers, servers, server blades, or the like) and/or other computer components (e.g., processors, memories, communication interfaces).

Enterprise computing infrastructure 120 may include one or more computing devices and/or other computer components (e.g., processors, memories, communication interfaces). In addition, enterprise computing infrastructure 120 may be configured to host, execute, and/or otherwise provide applications to one or more enterprise user computing devices 140. For example, enterprise computing infrastructure 120 may be configured to host, execute, and/or otherwise provide one or more applications, such as, for example, security applications, human resource applications, financial applications, and/or other applications associated with an enterprise server. In some instances, enterprise computing infrastructure 120 may be configured to provide various enterprise and/or back-office computing functions for an enterprise organization. For example, enterprise computing infrastructure 120 may include various functions that communicate with servers and/or databases that store and/or otherwise maintain customer information, such as personal information including name, address, telephone number, an electronic mail address, date of birth, social security number, and so forth. Additionally or alternatively, enterprise computing infrastructure 120 may receive instructions from multi-dimensional API computing platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain enterprise data. For example, enterprise data storage platform 130 may be configured to store and/or otherwise maintain, customer information, such as personal information including name, address, telephone number, an electronic mail address, date of birth, social security number, and so forth. Additionally or alternatively, enterprise computing infrastructure 120 may load data from enterprise data storage platform 130, manipulate and/or otherwise process such data, and return modified data and/or other data to enterprise data storage platform 130 and/or to other computer systems included in computing environment 100.

Enterprise user computing device 140 may include one or more computing devices and/or other computer components (e.g., processors, memories, communication interfaces). In some embodiments, enterprise user computing device 140 may be configured to provide in-session data to users of the enterprise organization. In some embodiments, enterprise user computing device 140 may be a personal computing device (e.g., desktop computer, laptop computer) or mobile computing device (e.g., smartphone, tablet, wearable device), that may be a source of information.

External computing device 150 may include one or more computing devices and/or other computer components (e.g., processors, memories, communication interfaces). In some embodiments, external computing device 150 may be configured to generate an encrypted key for an attribute. In some embodiments, external computing device 150 may be configured to generate the encrypted key based on a one way hash algorithm. In some embodiments, external computing device 150 may be a personal computing device (e.g., desktop computer, laptop computer) or mobile computing device (e.g., smartphone, tablet, wearable device), that may be a source of information. Generally, external computing device 150 may be a service provider that facilitates communication of enterprise data to third parties. In some embodiments, external computing device 150 may include marketing execution partner platforms, direct marketing partner platforms, third party digital platforms, such as social networking sites, and so forth.

Computing environment 100 also may include one or more networks, which may interconnect one or more of multi-dimensional API computing platform 110, enterprise computing infrastructure 120, enterprise data storage platform 130, enterprise user computing device 140, and/or external computing device 150. For example, computing environment 100 may include a private network 160 (which may, e.g., interconnect multi-dimensional API computing platform 110, enterprise computing infrastructure 120, enterprise data storage platform 130, enterprise user computing device 140, and/or one or more other systems which may be associated with an organization, and public network 170 (which may, e.g., interconnect enterprise user computing device 140 with private network 160 and/or one or more other systems, public networks, sub-networks, and/or the like). Public network 170 may be a cellular network, including a high generation cellular network, such as, for example, a 5G or higher cellular network. In some embodiments, private network 160 may likewise be a high generation cellular enterprise network, such as, for example, a 5G or higher cellular network. In some embodiments, computing environment 100 also may include a local network (which may, e.g., interconnect enterprise user computing device 140 and one or more other devices with each other).

In one or more arrangements, enterprise computing infrastructure 120, enterprise data storage platform 130, enterprise user computing device 140, and/or external computing device 150, and/or the other systems included in computing environment 100 may be any type of computing device capable of receiving input via a user interface, and communicating the received input to one or more other computing devices. For example, enterprise computing infrastructure 120, enterprise data storage platform 130, enterprise user computing device 140, and/or external computing device 150, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of multi-dimensional API computing platform 110, enterprise computing infrastructure 120, enterprise data storage platform 130, enterprise user computing device 140, and/or external computing device 150, may, in some instances, be special-purpose computing devices configured to perform specific functions.

Referring to FIG. 1B, multi-dimensional API computing platform 110 may include one or more processors 111, memory 112, and communication interface 113. A data bus may interconnect processor 111, memory 112, and communication interface 113. Communication interface 113 may be a network interface configured to support communication between multi-dimensional API computing platform 110 and one or more networks (e.g., network 160, network 170, a local network, or the like). Memory 112 may include one or more program modules having instructions that when executed by processor 111 cause multi-dimensional API computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of multi-dimensional API computing platform 110 and/or by different computing devices that may form and/or otherwise make up multi-dimensional API computing platform 110. For example, memory 112 may have, store, and/or include a record generation engine 112a, a payload uploading engine 112b, a key storing engine 112c, and a key lookup engine 112d.

Record generation engine 112a may have instructions that direct and/or cause multi-dimensional API computing platform 110 to submit, via a first computing device, a query for data associated with a user. In some embodiments, record generation engine 112a may have instructions that direct and/or cause multi-dimensional API computing platform 110 to receive, via the first computing device, a search result comprising an attribute of the user. In some embodiments, record generation engine 112a may have instructions that direct and/or cause multi-dimensional API computing platform 110 to generate, based on the attribute of the user, a data file comprising an attribute identifier associated with the attribute of the user.

Payload uploading engine 112b may have instructions that direct and/or cause multi-dimensional API computing platform 110 to upload, via a web interface and to a second computing device, the data file comprising the attribute identifier. In some embodiments, payload uploading engine 112b may have instructions that direct and/or cause multi-dimensional API computing platform 110 to receive, via the web interface and from the second computing device, an encryption key corresponding to the attribute identifier. Key storing engine 112c may have instructions that direct and/or cause multi-dimensional API computing platform 110 to store, via the first computing device and in a database, an association between attribute, the attribute identifier, and the encryption key. Key lookup engine 112d may have instructions that direct and/or cause multi-dimensional API computing platform 110 to match, via the first computing device and in the database, an attribute identifier or an encryption key with protected data associated with the user. In some embodiments, key lookup engine 112d may have instructions that direct and/or cause multi-dimensional API computing platform 110 to retrieve, via the first computing device and from the database, the protected data.

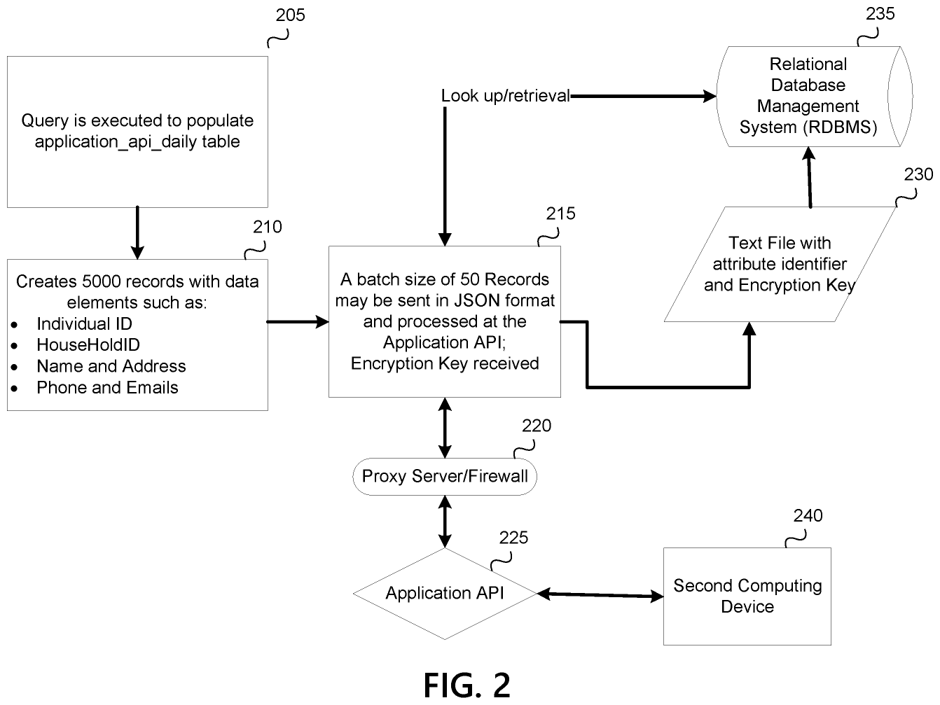

FIG. 2 depicts an illustrative data flow for encryption of protected data for data transmission over a web interface. Generally, an enterprise organization may process a various types of data, and there may be an external vendor, such as a data management vendor, that may facilitate management, transmission, storage, and/or update of such data. Data may include, for example, data associated with demographic information, market segment information (e.g., household income, age group, residential information, lifestyle, date of birth, age, and so forth). In some instances, certain types of data may be protected data. For example, there are more than thirty (30) known types of protected data. These may include protected personal information (e.g., personally identifiable information (“PII”)), protected health information (“PHI”), personal credit information protected under the payment card industry data security standard (“PCI”). For example, PII generally refers to any data that may be potentially utilized to identify a particular person. Such data, may include, for example, a full name, a social security number, a driver's license number, a passport number, a bank account number, an electronic mail address, and so forth. PHI may be any health information that may be associated with a name, a geographical identifier, a phone number, a fax number, a social security number, a medical health record number, and so forth. Also, for example, PCI data may be any form of cardholder data, for example, associated with a credit card and/or a debit card.

In some embodiments, the process may begin at 205. As customer data is uploaded and/or modified by enterprise computing infrastructure (e.g., enterprise computing infrastructure 120), such data may be retrieved and prepared for transmission to a vendor (e.g., external computing device 150). For example, multi-dimensional API computing platform 110 may submit, via a first computing device, a query for data associated with a user. Such a query may be submitted to an enterprise data storage platform (e.g., enterprise data storage platform 130). For example, multi-dimensional API computing platform 110 may query the enterprise data storage platform (e.g., enterprise data storage platform 130) to determine if customer data has been modified, and may receive, via the first computing device, a search result comprising an attribute of the user. For example, the attribute may be an individual identifier, a household identifier, a name and address, a telephone number, an electronic mail address, and so forth.

In some embodiments, the query may be generated as a uniform resource locator (“URL”), in JavaScript Object Notation (“JSON”) format, and/or in Extensible Markup Language (“XML”). For example, a query in the JSON format may be: “select IndividualID, HouseholdID, oreplace(oreplace(FirstNames, “ ”, ‘ ’), “ ”,”), oreplace(oreplace(MiddleNames, “ ”, ‘ ’), “ ”,”), oreplace(oreplace(LastNames, “ ”, ‘ ’), “ ”,”), oreplace(oreplace(Addresses_Line1, “ ”, ‘ ’), “ ”,”), oreplace(oreplace(Addresses_City, “ ”, ‘ ’), “ ”,”), Addresses_State, Addresses_Zip, Phones, Emails from pilot_mts.application_api_daily. In some embodiments, the search result may be returned in the JSON or XML format.

In some embodiments, multi-dimensional API computing platform 110 may validate the search result based on the format (e.g., JSON format). In some embodiments, multi-dimensional API computing platform 110 may create an api_table and populate the table with the contents of the search result. For example, as attributes are updated and/or modified, multi-dimensional API computing platform 110 may query the database, retrieve updated data, and update the api_table. In some embodiments, multi-dimensional API computing platform 110 may update the table at periodic intervals (e.g., daily).

In some embodiments, at 210, multi-dimensional API computing platform 110 may generate, based on the attribute of the user, or based on the updated api_table, a data file comprising an attribute identifier associated with the attribute of the user. For example, the data file may be a record that includes the search results, such as, for example, multi-dimensional attributes such as the individual identifier, the household identifier, the name and address, the telephone number, the electronic mail address, and so forth. In some embodiments, multi-dimensional API computing platform 110 may generate 5000 records, where each record may be associated with a user. Generally, the number of records sent over the API may depend on several factors. Also, for example, the records may be sent over in JSON format, which is independent of a particular formal programming language. In some embodiments, a sub-plurality (e.g., 50 records) of the plurality of records (e.g., 5000 records) may be transmitted as a batch.

The attribute identifier may be a sequential number. In some instances, the attribute identifier may be predictable. In some embodiments, the attribute identifier may be determined for a user. For example, an individual user may be associated with an individual identifier. In some embodiments, the attribute identifier may be determined for a group that includes the user. For example, the group may be a household, and the household may be associated with a household identifier.

An enterprise organization may provide data files to a partnering entity that may manage the data, and/or facilitate partnerships with other organizations. For example, the partnering entity may facilitate advertisement campaigns, marketing initiatives, customer outreach, discount programs, and so forth. In some instances, a marketing hub may determine campaign criteria and manage production lists. The trend in marketing continues to be to tailor the message to the individual, and customize the message for the individual. Social media may include shared information that enables advertisers to tailor their content to specific customer segments. Generally, the partnering entity may receive user data from a variety of sources, such as, for example, partner data from partners, prospect data from data brokers, and credit rating data from consumer protection agencies. Accordingly, the partnering entity may store the user data in a repository.

An enterprise organization may provide periodic updates to the partnering entity by providing updated data to the partnering entity. Accordingly, when the partnering entity receives a data file with an attribute identifier, the partnering entity may perform a match with existing data in its repository to update and/or modify the user data received from the other sources. For example, the partnering entity may have received a user's social security number and a name from a first source, and the enterprise organization may provide attribute identifiers associated with the name and a residential address. Accordingly, the partnering entity may perform a match with the existing user data in its repository to update and/or modify the user data to include the name, residential address, and the user's social security number.

Accordingly, in some embodiments, at 215, multi-dimensional API computing platform 110 may upload, via a web interface 225 and to a second computing device 240, the data file comprising the attribute identifier. For example, multi-dimensional API computing platform 110 may upload the data file as a single file, a compound file, or may upload a collection of data files as a batch. Generally, the upload may be through a proxy server or firewall 220. Also, for example, the uploaded data file or batch may be appropriately encrypted for transmission across the firewall. In some embodiments, the uploaded data file or batch may be provided in a JSON format. For example, a data file uploaded in the JSON format may be as follows:

| | json_out=“${json_out}{ \“99\”:\“800\”,\“4229\”: \”{ |
|---|---|
| | \\\“UserData\\\”:{ |
| | \\\“IndividualID\\\”: \\\“$univ_id\\\”, |
| | \\\“HouseholdID\\\”: \\\“$univcl_id\\\” }, |
| | \\\“FirstNames\\\”:[\\\“$first_name\\\”],\\\“MiddleNames\\\”: |
| [\\\“$middle_name\\\”], | |
| | \\\“LastNames\\\”: [\\\“$last_name\\\”], |
| | \\\“Addresses\\\”: [{\\\“Linel\\\”: \\“$address\\\”,\\\“City\\\”: |
| \\\“$city_name\\\”, | |
| | \\\“State\\\”: \\\“$state\\\”,\\\“Zip\\\”: \\\“$zip\\\” }],\\\“Phones\\\”: |

[\\\“$phone\\\”], \\\“Emails\\\”: [\\\“$email_address\\\”]}\“}”

As indicated, a first attribute identifier, IndividualID with value “$univ_id” associated with an individual may be provided. Also, for example, a second attribute identifier, HouseholdID with value “$univcl_id” associated with a household may be provided. Also, for example, the first attribute identifier and the second attribute identifier may be associated with user data such as a name (first, middle, last), and an address. Accordingly, second computing device 240 may receive the data file and may match the first attribute identifier and the second attribute identifier to existing attribute identifiers in its database, and based on the match, may update the user data associated with the first attribute identifier and the second attribute identifier. For example, second computing device 240 may update the user data to add the name (first, middle, last), and the address. In some instances, there may be no match with existing data. Accordingly, second computing device 240 may create a new entry in the repository for the first attribute identifier, IndividualID with value “$univ_id” associated with an individual, and the second attribute identifier, HouseholdID with value “$univcl_id” associated with a household, and may associate the identifiers with the user data such as the name (first, middle, last), and the address.

Generally, the web interface or API 225 may comprise a multi-dimensional characteristic. For example, a first dimension may be indicative of a number of data attributes that may be transferred via web interface 225. Also, for example, a second dimension may be indicative of a number of data files in a batch (e.g., a size of a batch) may be transferred via web interface 225. As another example, a third dimension may be indicative of a length of time that the data attributes persist in web interface 225, before being removed, and/or deleted. Also, for example, a fourth dimension may be indicative of an encryption key transferred via web interface 225. Generally, web interface 225 may implement a “GetData” model. For example, integers may be utilized to identify search parameters as key identifiers. Also, for example, attribute identifiers may be utilized as response selectors.

In some embodiments, multi-dimensional API computing platform 110 may determine, based on a web interface, a size of a batch comprising a plurality of data files associated with a plurality of users. For example, the web service may be an application programming interface (“API”) 225. Accordingly, multi-dimensional API computing platform 110 may determine the size of the batch based on the configurations of the API 225. The API 225 may facilitate a request/response process with the vendor (e.g., external computing device 150). The API 225 may determine a size of the payload.

In data transmission over a web API 225, one of the factors may be to not overload the system, and/or not wait for a long time. For example, there may be a threshold number of records that me be uploaded to the API 225. Also, for example, there may be a time threshold to upload the records to the API 225 before a time-out event occurs. Generally, based on the length of time and the complexity with regard to the records, multi-dimensional API computing platform 110 may determine a size of the batch so as to receive a response back within a reasonable period time, and without a need to send a large volume of records, and receive an error message. In some embodiments, the size of the batch may be, for example, 50 records.

As the records are uploaded onto the web interface and remain at the interface for a certain period of time, there may be a risk of the records being vulnerable to unauthorized access, and/or retrieval. Accordingly, multi-dimensional API computing platform 110 may remove, after the time interval, the batch from the web interface. In some embodiments, multi-dimensional API computing platform 110 may determine the size of the batch to minimize the time interval for the batch to remain on the web interface, thereby decreasing the risk of the vulnerability to unauthorized activity. Generally, multi-dimensional API computing platform 110 may determine the size of the batch, and/or the time interval for the batch to remain on the web interface, by comparing a risk versus a time to process a payload on the web interface. Also, for example, multi-dimensional API computing platform 110 may determine the size of the batch, and/or the time interval for the batch to remain on the web interface, by ensuring that a response time remains within a time threshold so that a connection to the web interface does not expire, due to, for example, exceeding the time threshold.

In some embodiments, multi-dimensional API computing platform 110 may receive, via the web interface 225, an error message indicative of a failure to upload the batch. For example, a size of the batch may exceed a capacity of the web interface 225, and the error message may be generated indicating that the size of the batch exceeded the capacity. As another example, a time taken to upload the batch may exceed a time threshold, resulting in a loss of connection to the web interface 225. Accordingly, the error message may be generated indicating that the time taken to upload the batch exceeded the time threshold. In some embodiments, multi-dimensional API computing platform 110 may respond to the error message by repeating the upload of the batch. In some embodiments, multi-dimensional API computing platform 110 may modify the size of the batch to conform to the capacity of the web interface 225. Also, for example, multi-dimensional API computing platform 110 may modify the size of the batch so that the time taken to upload the batch does not exceed the time threshold.

Generally, data files may include protected data and non-protected data. Non-protected data may be, for example, meta-data about a customer that is not protected data. For example, for marketing purposes, non-protected data may be related to demographic information or market segmentation information (e.g. household income, age group, life style, etc.). The term “external computing device” as used herein, generally refers to a device external to an enterprise organization, that may have access to data from the enterprise organization. As the vendor may store and/or process the data, it may be of high significance for the enterprise organization to maintain encryption keys corresponding to protected data and transmit files with non-protected data and encrypted versions of protected data. As described herein, data files may be transmitted via a secure file transfer protocol (“SFTP”). Generally, the data files may be sent in batches, where size of a batch may depend on a type of web interface 225 available. In some embodiments, a batch may include 50 records or data files, where each record may be associated with a user.

In some embodiments, at 215, multi-dimensional API computing platform 110 may receive, via the web interface 225 and from the second computing device 240, an encryption key corresponding to the attribute. For example, second computing device 240 may receive the data file and/or batch, and may generate, for each attribute, an encryption key. In some embodiments, the second computing device 240 may generate the encryption key. For example, the encryption key may be generated by applying a hashing algorithm. In some embodiments, the encryption key may be based on a unidirectional hashing algorithm. For example, a “One Way Hash” may be utilized to generate the encryption key. Such a hash string or key may not be reverse engineered to recover the key and recover the protected data. Generally, data files may be encrypted in transit, for example, by virtue of the secure sockets layer (“SSL”) protocol utilized to transmit the data files. Accordingly, second computing device 240 may generate the encryption key and provide the encryption key to multi-dimensional API computing platform 110 at 215 via web interface 225.

For example, multi-dimensional API computing platform 110 may receive, via the web interface 225 and from the second computing device 240, a response to the example data file provided in JSON format. In some embodiments, the response may be in JSON format, such as, for example:

{“nsr”: “rn2”,“transid”:“1234”,“errorcode”:“0”,“response”:[{“4220”:{“UserData”:{“IndividualID”:“9y99a3q8fa”,“HouseholdID”:“06h52w0q8a1a0l5”},“Individual”:{“Matched”:“Y}}.

As indicated, the API 225 may be configured to perform an error check, and a response from the second computing device 240 may indicate that there is no error in transmission. Also, for example, the response from the second computing device 240 may indicate that there is a match for the “Individual” in the repository.

In some embodiments, for the first attribute identifier, IndividualID with value “$univ_id” associated with an individual, and the second attribute identifier, HouseholdID with value “$univcl_id” associated with a household, second computing device 240 may generate encryption keys. In some embodiments, the first encryption key may be a randomly generated alphanumeric 10 characters corresponding to the individual customer level attribute such as IndividualID. For example, the first encryption key with value “9y99a3q8fa” may be generated for the first attribute identifier, IndividualID with value “$univ_id”. Accordingly, multi-dimensional API computing platform 110 may receive an association of the first attribute identifier, IndividualID with the first encryption key with value “9y99a3q8fa”.

As another example, a second encryption key may be generated. In some embodiments, the first encryption key may be a randomly generated alphanumeric 15 characters corresponding to the household customer level attribute such as HouseholdID. For example, the second encryption key with value “06h52w0q8a1a0l5” may be generated for the second attribute identifier, HouseholdID with value “$univcl_id”. Accordingly, multi-dimensional API computing platform 110 may receive an association of the second attribute identifier, HouseholdID with the second encryption key with value “06h52w0q8a1a0l5”.

Generally, an attribute identifier such as, PartyID, such as for example, the customer level attribute identifier, IndividualID, or the household customer level attribute such as HouseholdID, may be available within an enterprise organization. The PartyID may be a sequential number that may be predictable. However, the encryption key may be made generally available to entities external to the enterprise organization, such as, for example, direct marketing hubs, advertisement platforms, social networking platforms, partner organizations, and so forth. However, the enterprise organization may maintain an association between the PartyID and the corresponding encryption key, thereby facilitating a lookup of the attributes associated with the encryption key.

Accordingly, in some embodiments, multi-dimensional API computing platform 110 may generate a text file 230. Generally, the text file 230 may include the encryption key for an attribute, and an identifier corresponding to the attribute. For example, the text file 230 may include, “IndividualID”: “$univ_id”; “9y99a3q8fa”, indicating an association between the first attribute identifier “$univ_id” associated with the first encryption key “9y99a3q8fa”. Also, for example, the text file 230 may include, “HouseholdID”: “$univcl_id”; “06h52w0q8a1a0l5”, indicating an association between the second attribute identifier “$univcl_id” associated with the second encryption key “06h52w0q8a1a0l5”.

Generally, the attribute identifier may be available internal to an enterprise organization. For example, enterprise users may access protected data within the enterprise via an enterprise user computing device (e.g., enterprise user computing device 140). For example, an enterprise user may be in a real-time session with an enterprise customer. The enterprise user may need to provide, to the enterprise customer, protected data associated with the enterprise customer. Accordingly, enterprise user may query a database with the identifier associated with the protected data, and multi-dimensional API computing platform 110 may retrieve and provide the protected data to the enterprise user computing device (e.g., enterprise user computing device 140) to be presented to the enterprise customer.

In some embodiments, multi-dimensional API computing platform 110 may store, via the first computing device and in a database, an association between the attribute, the attribute identifier, and the encryption key. For example, multi-dimensional API computing platform 110 may store the association, based on text file 230, in a relational data management system (“RDMS”) 235. In some embodiments, multi-dimensional API computing platform 110 may store the association in a decision tree based database (e.g., a CTREE database). In some embodiments, an association between an attribute identifier and an attribute may be stored in a first tabular format, and an association between an encryption key and an attribute may be stored in a second tabular format. In some embodiments, a pointer may link the attribute identifier in the first tabular format to the encryption key in the second tabular format. In some embodiments, RDMS 235 may be a TeraData ODP configured for a high capacity to handle large volumes of data.

For example, for data associated with a user in a file, and for a protected data associated with the user, multi-dimensional API computing platform 110 may store an association between the user, the protected data, and the encryption key for the protected data. For example, if an encryption key, <Key A>, is associated with protected data such as a name, <Name A>, of a user, <User A>, then multi-dimensional API computing platform 110 may store such data, and an association, in RDMS 235 (e.g., a TeraData ODP).

Also, for example, multi-dimensional API computing platform 110 may store, “IndividualID”: “$univ_id”; “9y99a3q8fa”, indicating an association between the first attribute identifier “$univ_id” associated with the first encryption key “9y99a3q8fa” in RDMS 235. As another example, multi-dimensional API computing platform 110 may store, “HouseholdID”: “$univcl_id”; “06h52w0q8a1a0l5”, indicating an association between the second attribute identifier “$univcl_id” associated with the second encryption key “06h52w0q8a1a0l5” in RDMS 235.

Associating the attribute identifier, the attribute and the encryption key may provide several secure data transmission options. For example, in some embodiments, multi-dimensional API computing platform 110 may receive, via the first computing device (e.g. enterprise user computing device 140) and over a secured network (e.g., private network 160), a second query comprising the attribute identifier. As described herein, the attribute identifier may be available within an enterprise organization. Accordingly, when an enterprise user looks up customer information, the enterprise user may utilize the attribute identifier to directly look up the customer information. For example, an enterprise user may be in a real-time online session with a customer, and the customer may request information related to an account. Accordingly, enterprise user may utilize the attribute identifier to submit a query to directly look up the customer information.

In some embodiments, multi-dimensional API computing platform 110 may match, via the first computing device (e.g. enterprise user computing device 140) and in the database (e.g., RDMS 235), the attribute identifier with the attribute associated with the user. For example, multi-dimensional API computing platform 110 may match “$univ_id” with the corresponding attribute in RDMS 235. Also, for example, multi-dimensional API computing platform 110 may match “$univcl_id” with the corresponding attribute in RDMS 235.

In some embodiments, multi-dimensional API computing platform 110 may retrieve, via the first computing device (e.g. enterprise user computing device 140) and from the database (e.g., RDMS 235), the attribute. Subsequently, multi-dimensional API computing platform 110 may provide, based on the second query and over the secured network (e.g., private network 160), the attribute. For example, multi-dimensional API computing platform 110 may display the attribute to the first computing device (e.g. enterprise user computing device 140). In some embodiments, multi-dimensional API computing platform 110 may display the attribute in a chat window associated with a live chat session with the customer. In some instances, the attribute may relate to protected information, and authorized users internal to the enterprise organization may be allowed access to the protected information via the attribute identifier.

However, users external to the enterprise organization may not be allowed access to the protected information. In such instances, the encryption key associated with the attribute identifier may be provided to the users external to the enterprise organization. For example, the encryption key may be provided to vendors, partners, marketing platforms, social networking platforms, and so forth. Accordingly, protected data may not be shared outside the enterprise organization.

In some embodiments, multi-dimensional API computing platform 110 may receive, via the first computing device (e.g. enterprise user computing device 140) and over the web interface (e.g., API 225), a second query comprising the encryption key. For example, a marketing platform may prepare a marketing campaign tailored to a particular user. Accordingly, the marketing platform may query multi-dimensional API computing platform 110 for an attribute, and may provide the corresponding encryption key to multi-dimensional API computing platform 110.

In some embodiments, multi-dimensional API computing platform 110 may match, via the first computing device (e.g. enterprise user computing device 140) and in the database (e.g., RDMS 235), the encryption key with the attribute associated with the user. For example, multi-dimensional API computing platform 110 may match the encryption key “9y99a3q8fa” with the attribute identifier “$univ_id” in RDMS 235, which may then be associated with the corresponding individual level attribute in RDMS 235. Also, for example, multi-dimensional API computing platform 110 may match the encryption key “06h52w0q8a1a0l5” with the attribute identifier “$univcl_id” in RDMS 235, which may then be associated with the corresponding individual household level attribute in RDMS 235.

In some embodiments, multi-dimensional API computing platform 110 may retrieve, via the first computing device (e.g. enterprise user computing device 140) and from the database (e.g., RDMS 235), a link to the attribute. Generally, the attribute itself may not be transmitted outside the enterprise organization. However, a secure link to the attribute may be provided. This may provide an additional layer of security to customer information in general, and protected data in particular. Subsequently, multi-dimensional API computing platform 110 may cause, based on the second query, the link to the attribute to be provided over an authenticated network. For example, multi-dimensional API computing platform 110 may cause second computing device 240 to display the link to the attribute. In some embodiments, multi-dimensional API computing platform 110 may cause second computing device 240 to display the attribute in a chat window associated with a live chat session with a customer. In some instances, the attribute may relate to protected information, and users to view the protected information may be allowed secure access to the protected information via the secured link.

As described herein, multi-dimensional API computing platform 110 may provide several improvements in computing technology. For example, an average of 120,000 records may be transferred every hour via web interface 225. As another example, a maximum transfer rate of 150,000 records per hour may be achieved. Also, for example, an average time a record persist over web interface 225 may be 30 milliseconds, thereby resulting in a considerable reduction of a loss due to an unauthorized access during transmission. As another example, an average of 78% match rate may be achieved, indicating that the external computing device 240 may be able to match records in a vendor database at an average of 78%. Also, for example, a maximum match rate of 83% may be achieved. Such performance metrics provide significant improvements.

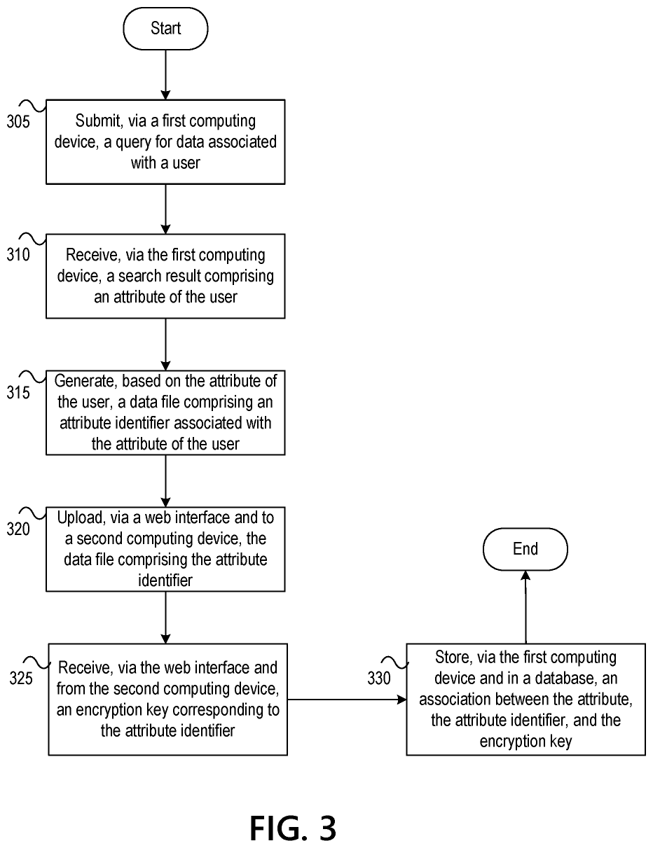

FIG. 3 depicts an illustrative method for encryption of protected data for data transmission over a web interface. Referring to FIG. 3, at step 305, a computing platform having at least one processor, a communication interface, and memory may submit, via a first computing device, a query for data associated with a user. At step 310, multi-dimensional API computing platform 110 may receive, via the first computing device, a search result comprising an attribute of the user. At step 315, multi-dimensional API computing platform 110 may generate, based on the attribute of the user, a data file comprising an attribute identifier associated with the attribute of the user. At step 320, multi-dimensional API computing platform 110 may upload, via a web interface and to a second computing device, the data file comprising the attribute identifier. At step 325, multi-dimensional API computing platform 110 may receive, via the web interface and from the second computing device, an encryption key corresponding to the attribute identifier. At step 330, multi-dimensional API computing platform 110 may store, via the first computing device and in a database, an association between the attribute, the attribute identifier, and the encryption key.

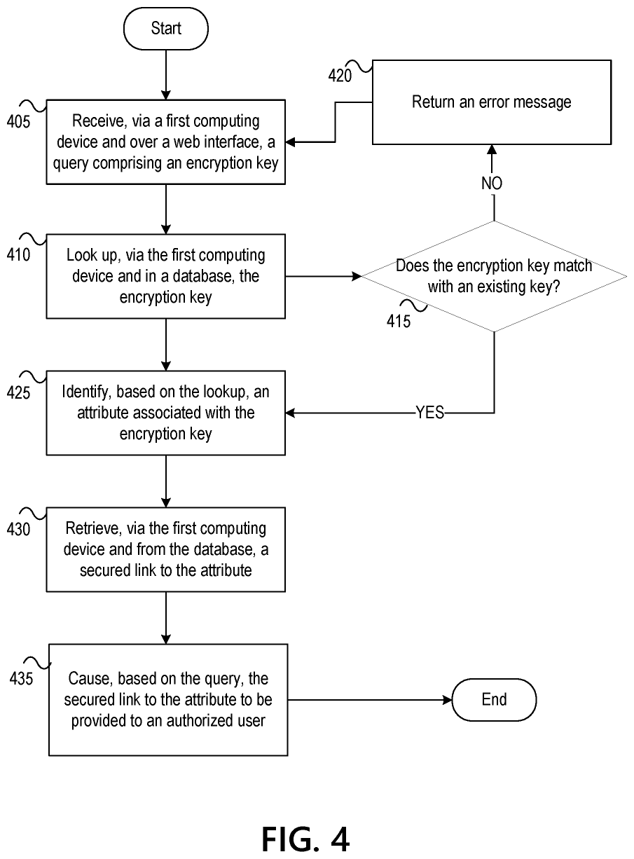

FIG. 4 depicts an illustrative method for encryption of protected data for data transmission over a web interface. Referring to FIG. 4, at step 405, a computing platform having at least one processor, a communication interface, and memory may receive, via a first computing device and over a web interface, a query comprising an encryption key. At step 410, multi-dimensional API computing platform 110 may look up, via the first computing device and in a database, the encryption key. At step 415, multi-dimensional API computing platform 110 may determine whether the encryption key matches a key stored in the database.

Upon a determination that the encryption key does not match a key stored in the database, multi-dimensional API computing platform 110 may proceed to step 420. At step 420, multi-dimensional API computing platform 110 may return an error message indicating that the encryption key does not match any keys stored in the database. Then, multi-dimensional API computing platform 110 may return to step 405 to receive another query comprising another encryption key.

Upon a determination that the encryption key matches a key stored in the database, multi-dimensional API computing platform 110 may proceed to step 425. At step 425, multi-dimensional API computing platform 110 may identify, based on the lookup, an attribute associated with the encryption key. At step 430, multi-dimensional API computing platform 110 may retrieve, via the first computing device and from the database, a secured link to the attribute. At step 435, multi-dimensional API computing platform 110 may cause, based on the query, the secured link to the attribute to be provided to an authorized user.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular time-sensitive tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor; and
memory storing computer-readable instructions that, when executed by the at least one processor, cause the computing platform to:
submit, via a first computing device, a query for data associated with a user;
receive, via the first computing device, a search result comprising an attribute of the user;
generate, based on the attribute of the user, a data file comprising an attribute identifier associated with the attribute of the user;
upload, via a web interface and to a second computing device, the data file comprising the attribute identifier;
receive, via the web interface and from the second computing device, an encryption key corresponding to the attribute identifier; and
store, via the first computing device and in a database, an association between the attribute, the attribute identifier, and the encryption key.

2. The computing platform of claim 1, wherein the instructions to provide the data file comprise additional computer-readable instructions that, when executed by the at least one processor, cause the computing platform to:
remove, after an elapse of a time threshold, the data file from the web interface.

3. The computing platform of claim 1, wherein the instructions to store the association comprise additional computer-readable instructions that, when executed by the at least one processor, cause the computing platform to:
modify, based on the search result, a table storing the attribute of the user.

4. The computing platform of claim 1, wherein the instructions comprise additional computer-readable instructions that, when executed by the at least one processor, cause the computing platform to:
receive, via the first computing device and over a secured network, a second query comprising the attribute identifier;
match, via the first computing device and in the database, the attribute identifier with the attribute associated with the user;
retrieve, via the first computing device and from the database, the attribute; and
provide, based on the second query and over the secured network, the attribute.

5. The computing platform of claim 1, wherein the instructions comprise additional computer-readable instructions that, when executed by the at least one processor, cause the computing platform to:
receive, via the first computing device and over the web interface, a second query comprising the encryption key;
match, via the first computing device and in the database, the encryption key with the attribute associated with the user;
retrieve, via the first computing device and from the database, a link to the attribute; and
cause, based on the second query, the link to the attribute to be provided over an authenticated network.

6. The computing platform of claim 1, wherein the encryption key is based on a unidirectional hashing algorithm.

7. The computing platform of claim 1, wherein the instructions comprise additional computer-readable instructions that, when executed by the at least one processor, cause the computing platform to:
generate the query in JavaScript Object Notation (JSON) format; and
validate, based on the JSON format, the search result.

8. The computing platform of claim 1, wherein the database is a Relational Database Management System (RDBMS).

9. The computing platform of claim 1, wherein the instructions comprise additional computer-readable instructions that, when executed by the at least one processor, cause the computing platform to:
determine, based on the web interface, a size of a batch comprising a plurality of data files associated with a plurality of users;
generate, based on the size, the batch of the plurality of data files;
upload, via the web interface and to the second computing device, the batch; and
remove, after a time interval, the batch from the web interface.

10. The computing platform of claim 9, wherein the instructions comprise additional computer-readable instructions that, when executed by the at least one processor, cause the computing platform to:
determine the size of the batch to minimize the time interval for the batch to remain on the web interface.

11. The computing platform of claim 9, wherein the instructions comprise additional computer-readable instructions that, when executed by the at least one processor, cause the computing platform to:
receive, via the web interface, an error message indicative of a failure to upload the batch; and
repeat, via the web interface and based on the error message, the upload of the batch.

12. The computing platform of claim 11, wherein the instructions comprise additional computer-readable instructions that, when executed by the at least one processor, cause the computing platform to:
modify the size of the batch based on the error message.

13. A method, comprising:
at a computing platform comprising at least one processor, and memory:
receiving, via a first computing device and over a web interface, a query comprising an encryption key;
looking up, via the first computing device and in a database, the encryption key;
identifying, based on the lookup, an attribute associated with the encryption key;
retrieving, via the first computing device and from the database, a secured link to the attribute; and
causing, based on the query, the secured link to the attribute to be provided to an authorized user.

14. The method of claim 13, wherein the encryption key is based on a unidirectional hashing algorithm.

15. The method of claim 13, further comprising:
receiving, via the first computing device and based on a query for data associated with a user, a search result comprising an attribute of the user;
generating, based on the attribute of the user, a data file;
uploading, via the web interface and to a second computing device, the data file comprising an attribute identifier associated with the attribute of the user;
receiving, via the web interface and from the second computing device, a second encryption key corresponding to the attribute identifier; and
storing, via the first computing device and in the database, an association between the attribute, the attribute identifier, and the encryption key.

16. The method of claim 15, further comprising:
removing, after an elapse of a time threshold, the data file from the web interface.

17. The method of claim 15, further comprising:
receiving, via the first computing device and over a secured network, a second query comprising the attribute identifier;
matching, via the first computing device and in the database, the attribute identifier with the attribute associated with the user;
retrieving, via the first computing device and from the database, the attribute; and
providing, based on the second query and over the secured network, the attribute.

18. The method of claim 13, further comprising:
determining, based on the web interface, a size of a batch comprising a plurality of data files associated with a plurality of users, wherein a data file of the plurality of data files comprises an attribute identifier associated with the attribute of the user;
generating, based on the size, the batch of the plurality of data files;
uploading, via the web interface and to the second computing device, the batch; and
removing, after a time interval, the batch from the web interface.

19. The method of claim 18, further comprising:
determining the size of the batch to minimize the time interval for the batch to remain on the web interface.

20. One or more non-transitory computer-readable media storing instructions that, when executed by a computing platform comprising at least one processor, and memory, cause the computing platform to:
submit, via a first computing device, a query for data associated with a user;
receive, via the first computing device, a search result comprising a plurality of attributes associated with a plurality of users;
generate, based on the plurality of attributes, a plurality of data files comprising a plurality of attribute identifiers associated with the plurality of attributes;
determine, based on a web interface, a size of a batch comprising a sub-plurality of the plurality of data files;
upload, via the web interface and to a second computing device, the batch;
receive, via the web interface and from the second computing device, encryption keys corresponding to the sub-plurality of the plurality of data files; and
store, via the first computing device and in a database, an association between the encryption keys and the sub-plurality of the plurality of data files.
